(19) United States
(12) Patent Application Publication
(10) Pub. No.: US 2019/0352128 A1
(43) Pub. Date: Nov. 21, 2019

(54) LEVITATING GUIDE SHOE ARRANGEMENT, A METHOD FOR GUIDING AN ELEVATOR CAR ALONG A STATOR BEAM OF AN ELECTRIC LINEAR MOTOR DURING AN EMERGENCY CONDITION AND AN ELEVATOR UTILIZING LEVITATING GUIDE SHOE ARRANGEMENT THEREOF

(71) Applicant: KONE Corporation, Helsinki (FI)

(72) Inventors: Tuukka Korhonen, Helsinki (FI); Jouni Ratia, Helsinki (FI); Tero Hakala, Helsinki (FI); Tero Purosto, Helsinki (FI)

(73) Assignee: KONE Corporation, Helsinki (FI)

(21) Appl. No.: 16/399,069

(22) Filed: Apr. 30, 2019

(30) Foreign Application Priority Data
May 15, 2018 (EP) 18172359.4

(51) Int. Cl. B66B 7/04

(52) U.S. Cl. CPC B66B 7/044; B66B 7/047

(57) ABSTRACT

A levitating guide shoe arrangement and a method for guiding an elevator car along a stator beam of an electric linear motor during an emergency condition are presented. A levitating guide shoe arrangement for guiding an elevator car along a stator beam of an electric linear motor during an emergency condition includes a levitating guide shoe and a guide surface. The guide surface is included in the stator beam. The levitating guide shoe is configured for arranging in an operating position with respect to the guide surface and includes a magnetic field generator configured to generate a magnetic field that extends to the guide surface. The arrangement is configured to establish an air gap between the levitating guide shoe and the guide surface by the magnetic field.

### TECHNICAL FIELD

The invention concerns in general the technical field of elevators. The invention concerns especially, however, not exclusively, to controlling of elevator car movement in case of an emergency condition.

### BACKGROUND

In multicar elevator systems, the elevator cars are driven by means of a linear motor. Linear motor has a longitudinal stator rail or beam arranged to extend along the elevator shaft. Each elevator car of the elevator has one or several rotor elements, or movers, coupled to the respective car and arranged in electromagnetic engagement with the stator rail and configured to provide elevator car movement along the stator rail.

The linear motor is controlled to have an air gap between stator and the movers, that is, the movers levitate relative to the stator. The air gap can be established by controlling the active parts of the motor. Active parts may include, for example, motor coils which may be controlled by means of power control of the motor, for example, an electrical drive such as a frequency converter.

In an emergency stop situation, for example, if the operation of the active parts of the linear motor fails for some reason during elevator run, such as if electricity supply to the active parts is unexpectedly interrupted or some of the active parts have failed, the controlling of the levitation by means of the active parts is no longer possible. In these situations, the movers may exhibit lateral movement and become in contact with the stator and/or the stator rail or beam, thus causing high friction and, therefore, excessive deceleration of the elevator car. This problem is severe especially when a car is travelling in upwards direction. The excessive deceleration may be uncomfortable or even harmful for the passengers in the elevator car.

It is known to use guide shoes, such as utilizing rollers or low-friction sliding surfaces, in elevators. Guide shoes are components used to ensure that the elevator car moves along the guide rail and that the lateral movement of the elevator car is minimized. Furthermore, known guide shoes, such as roller or sliding guide shoes, cause friction, noise and include parts which are prone to wearing, and thus increases the amount power needed to move the elevator car along the stator rail as well as require maintenance and/or replacement.

### SUMMARY

An objective of the present invention is to provide a levitating guide shoe arrangement, a method for guiding an elevator car along a stator beam of an electric linear motor during an emergency condition and an elevator utilizing the levitating guide shoe arrangement and/or the method. Another objective of the present invention is that by utilizing the levitating guide shoe arrangement and/or the method, a mechanical contact between the mover and the stator beam of the electric linear motor can be avoided or at least minimized or made less severe during the emergency condition.

The objectives of the invention are reached by a levitating guide shoe arrangement, a method and an elevator as defined by the respective independent claims.

According to a first aspect, a levitating guide shoe arrangement for guiding an elevator car along a stator beam of an electric linear motor during an emergency condition is provided. The levitating guide shoe arrangement comprises a levitating guide shoe and a guide surface, wherein the guide surface is comprised in the stator beam, and wherein the levitating guide shoe is configured for arranging in an operating position with respect to the guide surface and comprises magnetic field generation means for generating a magnetic field that extends to the guide surface, such as to generate eddy currents therein, wherein the arrangement is configured to establish an air gap between the levitating guide shoe and the guide surface by the magnetic field.

The emergency condition refers especially to conditions in which one or more of the active parts of the electrical linear motor, for example the mover or the stator, are not operable for some reason. Reasons for this may be interruption in the electrical power supply, a broken cable or electrical connection, failure of an electrical drive operating a mover or a stator, or any other reason causing the active parts to stop functioning. In some embodiments, the emergency condition may refer to a predetermined special operating situation, such as an overspeed situation of an elevator car or opening of a safety contact in an elevator safety circuit. The normal operating conditions, on the other hand, refer to conditions in which the elevator serves its landing floors in normal manner.

The guide surface may, preferably, be an electrically conducting surface.

The magnetic field generation means may comprise one or a plurality of electromagnets for generating the magnetic field, preferably as an alternating magnetic field.

The magnetic field generation means may comprise one or a plurality of permanent magnets for generating the magnetic field.

The magnetic field generation means may comprise a plurality of permanent magnets arranged in a Halbach array.

The levitating guide shoe may be configured to be coupled to a mover of the electric linear motor or to the elevator car, wherein the arrangement may be configured to establish an air gap between the mover and the stator beam.

The levitating guide shoe may comprise an actuator for changing a position of the magnetic field generation means relative to the guide surface.

According to a second aspect, a method for guiding an elevator car along a stator beam of an electric linear motor during an emergency condition is provided. The method comprises
detecting the emergency condition,
arranging a levitating guide shoe into an operating position with respect to a guide surface comprised in the stator beam, and
generating a magnetic field by magnetic field generation means comprised in the levitating guide shoe for establishing an air gap between the levitating guide shoe and the guide surface.

The magnetic field generation means may comprise one or a plurality of electromagnets, in which case in the method the generation of the magnetic field may comprise generating a magnetic field, preferably an alternating magnetic field, by the one or the plurality of electromagnets to engage with or to extend into the guide surface.

The levitating guide shoe may comprise one or a plurality of permanent magnets, in which case in the method the generation of the magnetic field may comprise generating a magnetic field by the one or the plurality of permanent magnets to engage with or to extend into the guide surface.

In the method, the levitating guide shoe may comprise a plurality of permanent magnets arranged in a Halbach array.

The arranging of the levitation guide shoe may be performed after the detection of the emergency condition by moving the levitating guide shoe into the operating position by an actuator.

Alternatively, the arranging of the levitation guide shoe may be performed prior to the detection of the emergency condition, and the generation of the magnetic field may then be performed after the detection of the emergency condition.

According to a third aspect, an elevator for guiding an elevator car along a stator beam of an electric linear motor during an emergency condition is provided. The elevator comprises an arrangement according to the first aspect.

In the elevator, the guide surface comprised in the stator beam may be common to the levitating guide shoes of the plurality of said arrangements according to the first aspect.

The present invention provides a levitating guide shoe arrangement, a method for guiding an elevator car along a stator beam of an electric linear motor during an emergency condition and an elevator. The present invention provides an advantage over known solutions such that in emergency conditions, particularly in ones in which the active parts of the electric linear motor of the elevator are disabled or unusable, a contact between the motor parts can be avoided or at least made severe which further decreases the deceleration of the elevator car in the emergency condition. High deceleration of the elevator car may become even harmful for the passengers inside the elevator car.

Various other advantages will become clear to a skilled person based on the following detailed description.

The expression “a plurality of” refers herein to any positive integer starting from two, e.g. to two, three, or four.

The terms “first”, “second” and “third” do not denote any order, quantity, or importance, but rather are used to distinguish one element from another.

The exemplary embodiments of the present invention presented herein are not to be interpreted to pose limitations to the applicability of the appended claims. The verb “to comprise” is used herein as an open limitation that does not exclude the existence of also un-recited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

The embodiments of the present invention are illustrated by way of example, and not by way of limitation, in the figures of the accompanying drawings.

FIG. 1 illustrates schematically an elevator according to an embodiment of the present invention.

FIG. 2 illustrates schematically an elevator according to an embodiment of the present invention.

FIGS. 3A and 3B illustrate schematically an electric linear motor according to an embodiment of the present invention.

FIGS. 4A and 4B illustrate schematically levitating guide shoe arrangements according to embodiments of the present invention.

FIGS. 5A and 5B illustrate schematically a levitating guide shoe arrangement according to an embodiment of the present invention.

FIGS. 6A and 6B illustrate highly schematically a levitating guide shoe arrangement according to an embodiment of the present invention.

FIG. 7 illustrates a flow diagram of a method according to an embodiment of the present invention.

### DESCRIPTION OF SOME EMBODIMENTS

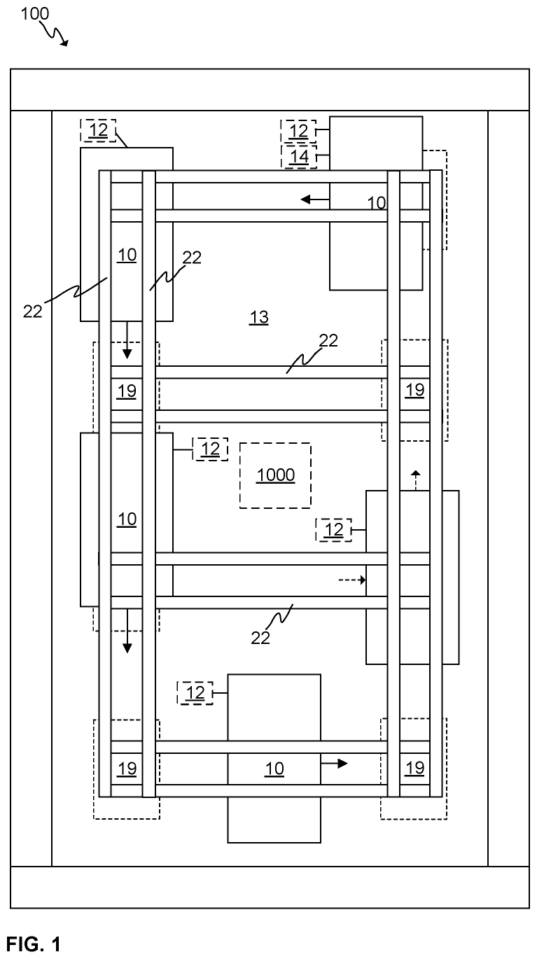

FIG. 1 illustrates schematically an elevator 100 according to an embodiment of the present invention. The elevator 100 may comprise at least one or a plurality of elevator cars 10 moving in the elevator shaft 13 or the elevator car pathway 13. The elevator car(s) 10 may comprise an electrical drive 12, such as a frequency converter or an inverter, and an energy storage 14 such as a battery or batteries and, optionally, a capacitor and/or a supercapacitor comprised in the elevator car 10 or cars 10.

The electrical drive 12 may be utilized for operating a mover or movers (not shown in FIG. 1) arranged to the elevator car 10 for moving the car 10 along the stator beam 22 of the electrical linear motor in the elevator shaft 13. There may also be other electrically operated equipment 25 in the elevator car 10 such as lighting, doors, user interface, emergency rescue equipment, etc. The electrical drive 12 or a further electrical drive, such as an inverter or a rectifier, may be utilized for operating one or several of said other equipment of the elevator car 10. The energy storage 14 may, preferably, be electrically coupled to the electrical drive 12, for example, to the intermediate circuit of the drive 12, for providing electrical power to the electrical drive 10 and/or for storing electrical energy provided by the electrical drive 12 or a further electrical drive or other electrical power source to the energy storage 14.

There are preferably at least two landing floors, having landing floor doors 19 or opening 19, comprised in the elevator 100. There may preferably also be doors comprised in the elevator car 10. Although shown in FIG. 1 that there are two horizontally separated sets, or “columns”, of vertically aligned landing floors 19, there could as well be only one column as in conventional elevators or more than two, for example, three columns.

Regarding the elevator shaft 13, it may be such as defining substantially closed volume in which the elevator car 10 is adapted and configured to be moved. The walls may be, for example, of concrete, metal or at least partly of glass, or any combination thereof. The elevator shaft 13 herein refers basically to any structure or pathway along which the elevator car 10 is configured to be moved and into which the stator beam 22 of the electric linear motor of the elevator may be arranged.

As can be seen in FIG. 1 with respect to the multi-car elevator 100, the elevator car 10 or cars 10 may be moved along the elevator shaft 13 vertically and/or horizontally depending on the direction of stator beams 22. According to embodiments similar to one in FIG. 1 in this respect, the elevator car 10 or cars 10 may be configured to be moved along a number of vertical and/or horizontal stator beams, for example, two beams 22 such as in FIG. 1. The stator beams 22 are part of an electric linear motor of the elevator 100 utilized to move the elevator car 10 or cars 10 in the elevator shaft 13. The stator beams 22 may, preferably, be arranged in fixed manner, that is, stationary with respect to the elevator shaft 13, for example, to a wall of the shaft by fastening portions.

The elevator 100 may comprise an elevator control unit 1000 for controlling the operation of the elevator 100. The elevator control unit 1000 may be a separate device or may be comprised in the other components of the elevator 100 such as in or as a part of the electrical drive 12. The elevator control unit 1000 may also be implemented in a distributed manner so that, e.g., one portion of the elevator control unit 1000 may be comprised in the electrical drive 12 and another portion in the elevator car 10. The elevator control unit 1000 may also be arranged in distributed manner at more than two locations or in more than two devices.

The elevator control unit 1000 may comprise one or more processors, one or more memories being volatile or non-volatile for storing portions of computer program code and any data values and possibly one or more user interface units. The mentioned elements may be communicatively coupled to each other with e.g. an internal bus.

The processor of the elevator control unit 1000 is at least configured to implement at least some method steps as described hereinafter. The implementation of the method may be achieved by arranging the processor to execute at least some portion of computer program code stored in the memory causing the processor, and thus the elevator control unit 1000, to implement one or more method steps as described. The processor is thus arranged to access the memory and retrieve and store any information therefrom and thereto. For sake of clarity, the processor herein refers to any unit suitable for processing information and control the operation of the elevator control unit 1000, among other tasks. The operations may also be implemented with a microcontroller solution with embedded software. Similarly, the memory is not limited to a certain type of memory only, but any memory type suitable for storing the described pieces of information may be applied in the context of the present invention.

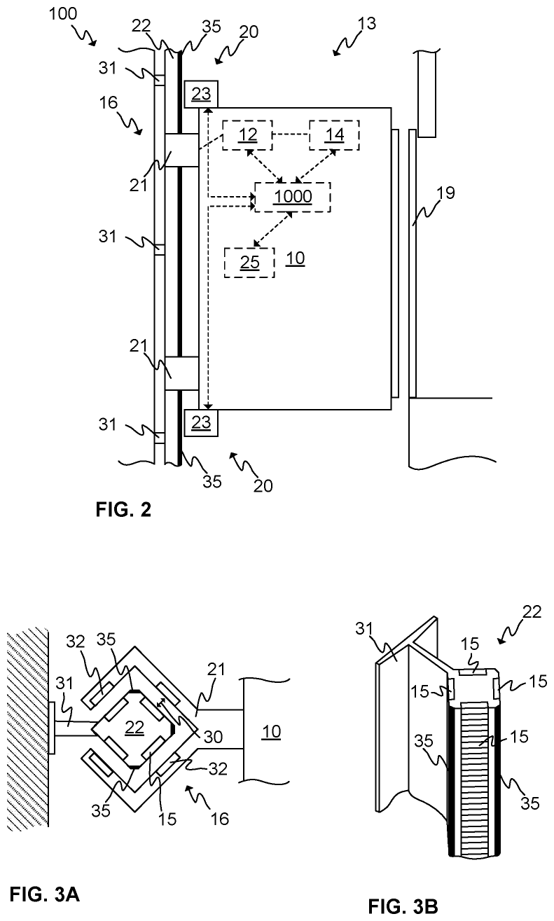

FIG. 2 illustrates schematically an elevator 100 comprising a levitating guide shoe arrangement 20 according to an embodiment of the present invention. There is one elevator car 10 illustrated from a side view in FIG. 2. The elevator car 10 may be configured to move in the elevator shaft 13 by the electric linear motor 16. There may be one or several movers 21 coupled to the elevator 10. The elevator car may comprise an electrical drive 12 or drives 12 for operating the mover 21 or movers 21. There may also be an energy storage 14 from which electrical power may be drawn by the electrical drive 12 to operate the mover 21 or movers 21.

Part of the levitating guide shoe arrangement 20 according to various embodiments may be coupled to the elevator car 10 or to the mover 21. The levitating guide shoe arrangement 20 may comprise a levitating guide shoe 23 and a guide surface 35 comprised in the stator beam 22. The levitating guide shoe 23 may, preferably, be arranged to be close to the guide surface it its operating position so as to enable establishing a magnetic engagement between the levitating guide shoe 23 and the guide surface 35 by magnetic field generating means such as an electromagnet or a permanent magnet. The levitating guide shoe arrangement 20 may be controlled by the elevator control unit 1000, that is, being at least communicatively coupled to the elevator control unit 1000.

FIGS. 3A and 3B illustrate schematically an electric linear motor 16 according to an embodiment of the present invention. FIG. 3A illustrates schematically an electric linear motor 16, or at least a part thereof, according to an embodiment of the present invention. The electric linear motor 16 comprises a mover 21, preferably, a C-shaped or U-shaped (not shown) mover 21. The mover 21 comprises at least one unit of electromagnetic components 32 comprising at least one coil and, optionally, preferably, permanent magnet(s) and/or magnetic core element(s) or ferromagnetic material. The unit or units of electromagnetic components 32 may, preferably, be comprised in the mover 21 and adapted to face the stator 15 or stators 15 of the stator beam 22, as shown in FIG. 3A, for instance. The units of electromagnetic components 32 are arranged to be in electromagnetic engagement with the stators 15 for moving the mover 21 along the stator beam 22. As can be seen, the mover 21 may be shaped and designed in such a way as to enable the movement of the mover 21 along the stator beam 22 without interference from the fastening or support portions 31. As can be seen, there is an air gap 30 between the mover 21 and the stator 15 of the stator beam 22. In normal operation conditions of the elevator, the air gap 30 may be established by controlling the active parts of the electric linear motor 16. The active parts, such as coils or windings, may be comprised in the mover 21 and/or in the stator beam 22. The air gap 30 may be maintained by utilizing magnetic field or force generated by the coils or windings of the electric linear motor 16 and, thus, the mover 21 is being levitated, or magnetically levitated, with respect to the stator beam 22.

The movement of the mover 21 along the stator beam 22 may be implemented by known control methods, such as, field-oriented or vector control or the like. The basic idea is to produce an alternating magnetic field, for example by an electrical drive 12, by injecting current to a unit of electromagnetic components 32 of the mover 21, such as to a winding or coil thereof. The unit of electromagnetic components 32 facing the stator 15 then co-acts with the stator 15 through the electromagnetic engagement and produces a force which moves the mover 21 and thus the elevator car 10 along the stator beam 22.

Furthermore, FIG. 3A illustrates a guide surface 35 of a levitating guide shoe arrangement 20 according to an embodiment of the present invention. The guide surface is also illustrated in FIG. 3B. There may be one or preferably several guide surfaces comprised in the stator beam 22 or beams 22. Furthermore, as shown in FIG. 2, there may be one or several levitating guide shoe arrangements 20 utilizing common guide surface 35 or surfaces 35. The guide surface 35 may preferably be electrically conducting surface, such as of aluminum or copper. The guide surface 35 may be an integral part of the stator beam 22 or it may have been arranged and attached on the stator beam 22 as a separate layer.

FIG. 3B illustrates schematically a part of the stator beam 22, or a stator beam part, according to an embodiment of the present invention by a perspective view. The part of the stator beam 22 comprises at least one stator 15 extending substantially along the whole stator beam 22. There may, advantageously, be four stators 15 arranged at all four sides of the stator beam 22. There may also be a fastening portion 31 or portions 31 by which said part 22 may be attached in fixed manner to the structures, such as a wall, of the elevator shaft 13. The stators 15 may, preferably, be of ferromagnetic material, such as iron, and comprise teeth on their outer surface. According to a preferable embodiment of the present invention, the stator beam 22 or beams 22 are passive in the sense that they do not comprise controllable elements or components, such as coils, for controlling the movement of the mover 21 along the stator beam 22. According to an embodiment, the stator beam 22 or beams 22 may, however, comprise such active parts, for example coils or windings, while the mover 21 may be essentially passive, that is, it may essentially comprise motor parts such as ferromagnetic material and/or permanent magnets only.

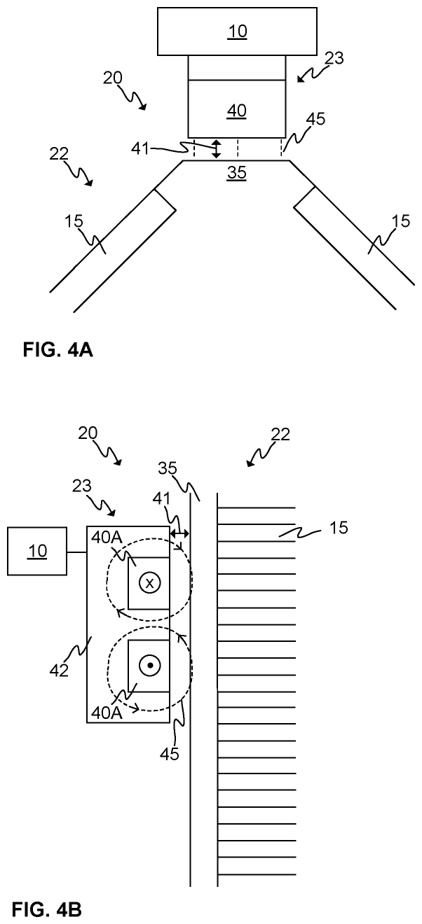

FIGS. 4A and 4B illustrate schematically levitating guide shoe arrangements 20 according to embodiments of the present invention. The arrangement 20 shown in FIG. 4A from above (that is, as viewed along the longitudinal direction of the stator beam 22) may preferably comprise a levitating guide shoe 23 and a guide surface 35 arranged to the stator beam 22. The levitating guide shoe 23 may be arranged coupled to the elevator car 10 (mechanical coupling between the shoe 23 and the car 10, which is not in scale, is shown in FIGS. 4A and 4B highly schematically) or the mover 21 (which may be coupled to the elevator car 10) of the electric linear motor 16. The levitating guide shoe 23 may comprise magnetic field generation means 40 for generating a magnetic field 45. The levitating guide shoe 23 may be arranged in an operating position in which the magnetic field 45 generated in the levitating guide shoe 23 affects or penetrates or extends the guide surface 35 of the stator beam 22 to generate eddy currents therein, that is, the levitating guide shoe 23 may need to be arranged close relative to the guide surface 35 in the operating position. The magnetic field 45 may thus be utilized to establish an air gap 41 between the levitating guide shoe 23 and the guide surface 35 at least during part of the emergency condition and, thus, prevent or at least minimize said two parts becoming in contact with one another. By coupling or attaching the levitating guide shoe 23 to the elevator car 10 or the mover 21 thereof, the levitating guide shoe arrangement 20 may be utilized in an emergency condition to prevent the contact or to make the contact less severe between the mover 21 and the stator beam 22. This has the advantage that the deceleration of the elevator car 10 can be reduced with respect to a situation where the contact between the mover 21 and the stator beam 22 occurs. The force causing the levitation of the levitating guide shoe arrangement 20 is based on eddy currents in the guide surface of the stator beam 22 acting with the magnetic field 45 produced by the levitating guide shoe 23.

FIG. 4B illustrates schematically a levitating guide shoe arrangement 20 according to an embodiment of the present invention form a side view. In FIG. 4B, the stator beam 22 has been depicted extending vertically next to the levitating guide shoe 23. The levitating guide shoe 23 may comprise an electromagnet. The electromagnet may preferably comprise a winding 40A or a coil 40A into which magnetic field generating current may be injected, that is, to operate as magnetic field generating means 40. The electromagnet may further comprise, for example, ferromagnetic material 42 as used in typical way in electromagnets and/or magnetic circuits. Otherwise, the embodiment of the levitating guide shoe arrangement 20 shown in FIG. 4B may be similar to the one illustrated in FIG. 4A. The electromagnet 40A may be used to generate an alternating or at least varying magnetic field 45, for example, by injecting alternating current to the coil 40A. The alternating or the at least varying magnetic field 45 may be used also with zero speed of the elevator car 10 or the mover 21, which is advantageous because then the operating range of the levitating guide shoe 23 can be extended to small velocities because the varying magnetic field 45 causes eddy currents to the guide surface 35 even if the elevator car 10 is essentially in place.

According to an embodiment of the present invention, the magnetic field generation means 40 of the levitating guide shoe 23 may comprise, alternatively or in addition, one or a plurality of permanent magnets. Thus, the magnetic field 45 may be constant or at least comprise a constant portion generated by the permanent magnet(s) in addition to the field 45 generated by the electromagnet.

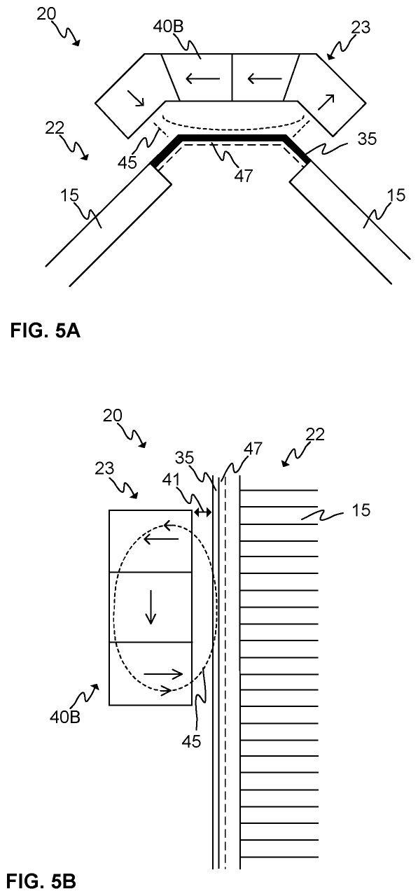

FIGS. 5A and 5B illustrate schematically a levitating guide shoe arrangement 20 according to an embodiment of the present invention. The levitating guide shoe 23 comprises a plurality of permanent magnet 40B arranged in a Halbach array. A Halbach array refers herein to an arrangement of permanent magnets that amplifies the magnetic field on one side of the array while cancelling or minimizing the field on the other side. The array may be linear or exhibit certain non-linear shape such as a C-shape as shown in FIG. 5A from above (that is, as viewed along the longitudinal direction of the stator beam 22). It is further shown in FIG. 5A that the guide surface 35 is a separate layer of conducting material, for example aluminum, arranged on the stator beam 22. There may also be an insulating layer 47 used between the guide surface 35 and the stator beam 22. FIG. 5B illustrates the embodiment of the arrangement 20 from a side view.

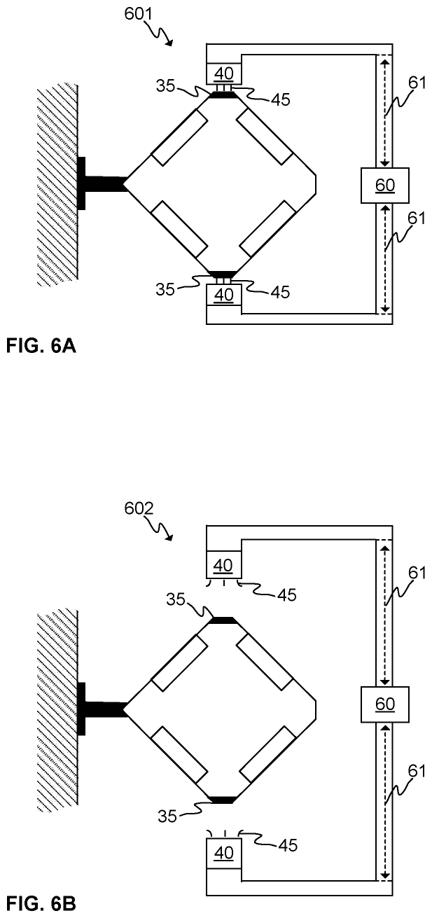

FIGS. 6A and 6B illustrate highly schematically a levitating guide shoe arrangement 20 according to an embodiment of the present invention. There may be two or more levitating guide shoes 23 and two or more guide surfaces 35 comprised in the arrangement 20. The arrangement 20 may further comprise an actuator 60 which may be utilized to move the levitating guide shoes 23 with respect to the respective guide surfaces 35. FIG. 6A illustrates the levitating guide shoes 23 being arranged into their operating positions 601, that is, to a distance/position with respect to the guide surface 35 so that the generated magnetic fields 45 is effectively affecting the guide surfaced 35. FIG. 6B illustrates the levitating guide shoes 23 in positions 602, i.e. in second positions 602, in which the magnetic fields 45 is affecting substantially less, if at all, to the guide surfaces 35. The actuator 60 may be used to change the positions of the levitating guide shoes 35, for example, by a rod or rods which lengths 61 may be adjusted by the actuator 60. However, the mechanism may also such that the actuator 60 changes the positions of the rods, for example, by a hinge so that the lengths 61 remain essentially unchanged but the positions of the levitating guide shoes 23 are being changed.

According to an embodiment of the present invention, the levitating guide shoe 23, for example being coupled to the elevator car 10, of the arrangement 20 may be arranged to a second position 602. Only after an emergency condition is detected, the levitating guide shoe 23 or shoes 23 are being changed into its or their operating positions 601 after which the magnetic field 45 may be used to establish or maintain the air gap 41 between the levitating guide shoe 23 and the respective guide surface 35. If the levitating guide shoe 23 is coupled to the elevator car 10, for instance, by establishing the air gap 41, the arrangement 20 may further be arranged such as to simultaneously establish a gap (that is, an air gap 30) between the mover 21 and the stator beam 22.

According to another embodiment of the present invention, if the levitating guide shoe 23 comprises an electromagnet comprising a coil 40A, there may no need to arrange the levitating guide shoe 23 or shoes 23 into any other position than the operating position 601. In such a case, the electromagnet may be kept inactive, that is not injecting current into the coil 40A, during normal operating conditions of the elevator 100 and only activated once an emergency condition has been detected. According to still another embodiment, if the levitating guide shoe 23 comprises a permanent magnet 40B or magnets 40B (such as in Halbach array), it may be especially advantageous to arranged the levitating guide shoe 23 or shoes 23 into its or their second positions 602 during the normal operation conditions of the elevator 100 and then to its or their operating positions 601 once an emergency condition has been detected in order to avoid generating eddy currents during the normal operation conditions of the elevator 100.

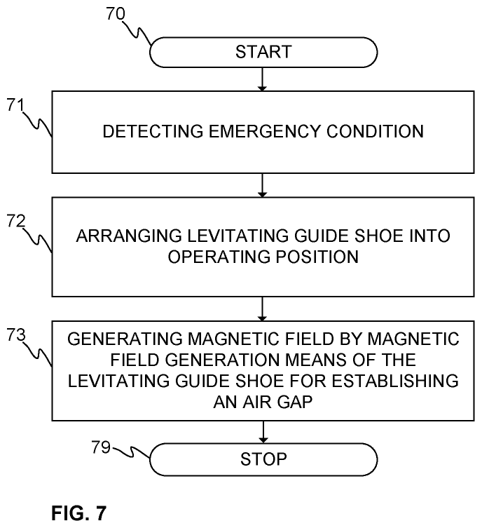

FIG. 7 shows a flow diagram of a method in accordance with an embodiment of the present invention. Step 70 refers to a start-up phase of the method. Suitable equipment and components are obtained and systems, such as the elevator 100, the stator beam 22 of the electric linear motor 16, the levitating guide shoe arrangement 20 may be assembled and configured for operation. Furthermore, the elevator control unit 1000 or a separate control unit may be configured to perform the method steps described hereinbelow.

Step 71 refers to detecting an emergency condition of the elevator 100. Herein the emergency condition refers especially to conditions in which the active parts of the electrical linear motor 16, for example the mover 16 or the stator 15, are not operable for some reason. Reasons for this may be interruption in the electrical power supply, a broken cable or electrical connection, failure of an electrical drive 12 operating a mover 16 or a stator 15, or any other reason causing the active parts to stop functioning. The detection 71 may relate to detecting a safety circuit related event. The detection 71 may be performed by the elevator control unit 1000 or a separate control unit comprising at least a processor.

Step 72 refers to arranging a levitating guide shoe 23 into an operating position 601 with respect to a guide surface 35 comprised in the stator beam 22. This may entail arranging it to the operating position 601 during the normal operation conditions of the elevator 100, for example, even before starting the normal operation conditions of the elevator 100, such as when the levitating guide shoe 23 comprises only electromagnets. On the other hand, the arranging 72 may be performed only after the detection 71 of the emergency condition, such as in case of utilizing permanent magnets in the levitating guide shoe 23. The arranging 72 may, according to some embodiment, be performed by an actuator 60.

Step 73 refers generating a magnetic field 45 by magnetic field generation means 40 comprised in the levitating guide shoe 23 for establishing an air gap 41 between the levitating shoe 23 and the guide surface 35. As stated hereinearlier, this may be performed by an electromagnet or electromagnets, a permanent magnet 40B or magnets 40B, such as arranged in Halbach array, or any combination thereof. The magnetic field 45 cause eddy currents in the guide surface 35 thus causing a force between the levitating guide shoe 23 and the guide surface 35 establishing an air gap 41 between the two. Furthermore, if the levitation guide shoe 23 has been coupled to the elevator car 10 or the mover 16 thereof, the magnetic field 45 may be simultaneously utilized to establish a gap between the mover 21 and the stator beam 22.

In case some movers or at least part of a mover is still in working order during the emergency stop, the operable mover(s) may be utilized in addition to provide propulsion force to reduce elevator car deceleration further to an acceptable level.

Method execution is stopped at step 79. Operation the elevator 100 may be continued in the normal operation conditions or in the emergency conditions.

Furthermore, the method may be performed continuously or intermittently, if necessary.

The specific examples provided in the description given above should not be construed as limiting the applicability and/or the interpretation of the appended claims. Lists and groups of examples provided in the description given above are not exhaustive unless otherwise explicitly stated.

1. A levitating guide shoe arrangement for guiding an elevator car along a stator beam of an electric linear motor during an emergency condition, the levitating guide shoe arrangement comprising:
a levitating guide shoe; and
a guide surface,
wherein the guide surface is comprised in the stator beam,
wherein the levitating guide shoe is configured for arranging in an operating position with respect to the guide surface and comprises: a magnetic field generator configured to generate a magnetic field that extends to the guide surface, and
wherein the arrangement is configured to establish an air gap between the levitating guide shoe and the guide surface by the magnetic field.

2. The levitating guide shoe arrangement according to claim 1, wherein the guide surface is an electrically conducting surface.

3. The levitating guide shoe arrangement according to claim 1, wherein the magnetic field generator comprises one or a plurality of electromagnets for generating the magnetic field.

4. The levitating guide shoe arrangement according to claim 1, wherein the magnetic field generator comprises one or a plurality of permanent magnets for generating the magnetic field, and wherein the magnetic field is an alternating magnetic field.

5. The levitating guide shoe arrangement according to claim 1, wherein the magnetic field generator comprises a plurality of permanent magnets arranged in a Halbach array.

6. The levitating guide shoe arrangement according to claim 1, wherein the levitating guide shoe is configured to be coupled to a mover of the electric linear motor or to the elevator car, and wherein the arrangement is configured to establish an air gap between the mover and the stator beam.

7. The levitating guide shoe arrangement according to claim 1, wherein the levitating guide shoe comprises an actuator for changing a position of the magnetic field generator relative to the guide surface.

8. A method for guiding an elevator car along a stator beam of an electric linear motor during an emergency condition, the method comprising:
detecting the emergency condition, condition;
arranging a levitating guide shoe into an operating position with respect to a guide surface comprised in the stator beam; and
generating a magnetic field by a magnetic field generator comprised in the levitating guide shoe for establishing an air gap between the levitating guide shoe and the guide surface.

9. The method according to claim 8, wherein the magnetic field generator comprises one or a plurality of electromagnets, and wherein in the method, the generation of the magnetic field comprises generating a magnetic field by the one or the plurality of electromagnets to engage with the guide surface.

10. The method according to claim 8, wherein the levitating guide shoe comprises one or a plurality of permanent magnets, and wherein in the method, the generation of the magnetic field comprises generating an alternating magnetic field by the one or the plurality of permanent magnets to engage with the guide surface.

11. The method according to claim 10, wherein the levitating guide shoe comprises a plurality of permanent magnets arranged in a Halbach array.

12. The method according to claim 8, wherein the arranging of the levitation guide shoe is performed after the detection of the emergency condition by moving the levitating guide shoe into the operating position by an actuator.

13. The method according to claim 8, wherein the arranging of the levitation guide shoe is performed prior to the detection of the emergency condition, and the generation of the magnetic field is performed after the detection of the emergency condition.

14. An elevator for guiding an elevator car along a stator beam of an electric linear motor during an emergency condition, wherein the elevator comprises the arrangement according to claim 1.

15. The elevator according to claim 14, comprising a plurality of said arrangements, wherein the guide surface comprised in the stator beam is common to the levitating guide shoes of the plurality of said arrangements.

16. The levitating guide shoe arrangement according to claim 2, wherein the magnetic field generator comprises one or a plurality of electromagnets for generating the magnetic field.

17. The levitating guide shoe arrangement according to claim 2, wherein the magnetic field generator comprises one or a plurality of permanent magnets for generating the magnetic field, wherein the magnetic field is an alternating magnetic field.

18. The levitating guide shoe arrangement according to claim 3, wherein the magnetic field generator comprises one or a plurality of permanent magnets for generating the magnetic field.

19. The levitating guide shoe arrangement according to claim 3, wherein the magnetic field generator comprises one or a plurality of permanent magnets for generating the magnetic field, wherein the magnetic field is an alternating magnetic field.

20. The levitating guide shoe arrangement according to claim 2, wherein the magnetic field generator comprises a plurality of permanent magnets arranged in a Halbach array.
